(19) United States
(12) Patent Application Publication
(10) Pub. No.: US 2026/0319542 A1
(43) Pub. Date: Oct. 15, 2026

(54) USING A FIBER OPTIC SIGNAL TO SYNCHRONIZE A SYSTEM CLOCK

(71) Applicant: INTERNATIONAL BUSINESS MACHINES CORPORATION, ARMONK, NY (US)

(72) Inventors: VADIM ELISSEEV, Warrington (GB); Christopher J. Vollmar, Mississauga (CA); Frank N. Lee, Sunset Hills, MO (US)

(21) Appl. No.: 19/178,156

(22) Filed: Apr. 14, 2025

(51) Int. Cl. G06F 1/10; G06F 1/12

(52) U.S. Cl. CPC G06F 1/105; G06F 1/12

(57) ABSTRACT

Disclosed embodiments include facilitating clock synchronization and/or synchronous playback among multiple playback devices in a group. An individual playback device estimates and/or calculates a clock time at a clock time source (or a time offset/error between the playback device and the clock time source) based on (i) first clock timing received from the clock time source via a primary timing link and (i) second clock timing received from the clock time source via a secondary timing link. In some embodiments, estimating and/or calculating a clock time and/or clock time off set/error comprises estimating and/or calculating the clock time and/or clock time off set/error with a state estimator, such as a Kalman filter, an extended Kalman filter, or other state estimator configured to estimate a clock time and/or clock time error based on clock timing received via two or more communications links.

### BACKGROUND OF THE INVENTION

The present invention relates to a computer program product, system, and method for using a fiber optic signal to synchronize a system clock.

Correct and tightly synchronized clocks in network computer systems are mandatory for efficient network operations. This includes protecting the integrity of transactions and ensuring ongoing operations when an environment is under threat. Data retention, protection and isolation on storage devices, backup/archive and other systems are increasingly managed with time based policy locks.

Clocks depend on crystal oscillator frequencies, which change in time due to manufacturing imperfections and environmental factors. Existing time synchronization protocols assume an unknown oscillator frequency and use in-band software algorithms for clocks adjustments. These algorithms use time stamps and depend on quality of data transmission between devices.

### SUMMARY

Provided are a computer program product, system, and method for using a fiber optic signal to synchronize a system clock. A modulated optical signal from a transceiver is inputted to a spectrometer to calculate a frequency from a spectrum of the modulated optical signal. A determination is made of a clock adjustment to the system clock based on the calculated frequency. The clock adjustment is sent to adjust the system clock to measure time at the calculated frequency.

### BRIEF DESCRIPTION OF THE DRAWINGS

FIG. 1 illustrates an embodiment of a computational device to synchronize time of an internal system clock.

FIG. 2 illustrates an embodiment of a computational device and time server to manage time synchronization of a system clock in the computational device.

FIG. 3 illustrates an embodiment of operations to synchronize a system clock using a fiber optic signal with the embodiments of FIGS. 1 and 2.

FIG. 4 illustrates an embodiment of a time server synchronizing time among a plurality of computational devices over a fiber optic network.

FIG. 5 illustrates an embodiment of operations to synchronize system clocks on computational devices using a fiber optic signal with the embodiment of FIG. 4.

FIG. 6 illustrates a computing environment in which the components of FIGS. 1, 2, and 3 may be implemented.

### DETAILED DESCRIPTION

Malicious attacks and deteriorating equipment may result in the system clock time diverging from a real current time. Described embodiments provide improved computer technology for synchronizing a system clock.

Described embodiments include a spectrometer in a computational device or time server to process a modulated optical signal, such as a phase modulated optical signal. The spectrometer processes a spectrum of the optical signal to calculate a frequency of the clock. The calculated frequency may be processed with a frequency produced by a crystal oscillator of the system clock to determine a frequency and/or time adjustment to be made to the system clock.

The frequency adjustment modifies the frequency at which time is measured in the computational device, such as the frequency at which ticks are counted in a timer counter to measure time.

Described embodiments may have a time server receive a modulated optical signal, such as a phase or amplitude modulated signal, from one or more computational devices over an fiber optic network and determine the frequencies from the received phase modulated optical signal. The frequency of the signal used for modulation calculated from the optical signal for the computational device may then be used to adjust the frequency at which the computational device measures time to correspond to the calculated frequency. Further, described embodiments may determine a derived frequency from the calculated frequencies from optical signals from multiple computational devices. This derived frequency may be used to adjust the frequency of all the connected computational devices sending the optical signals.

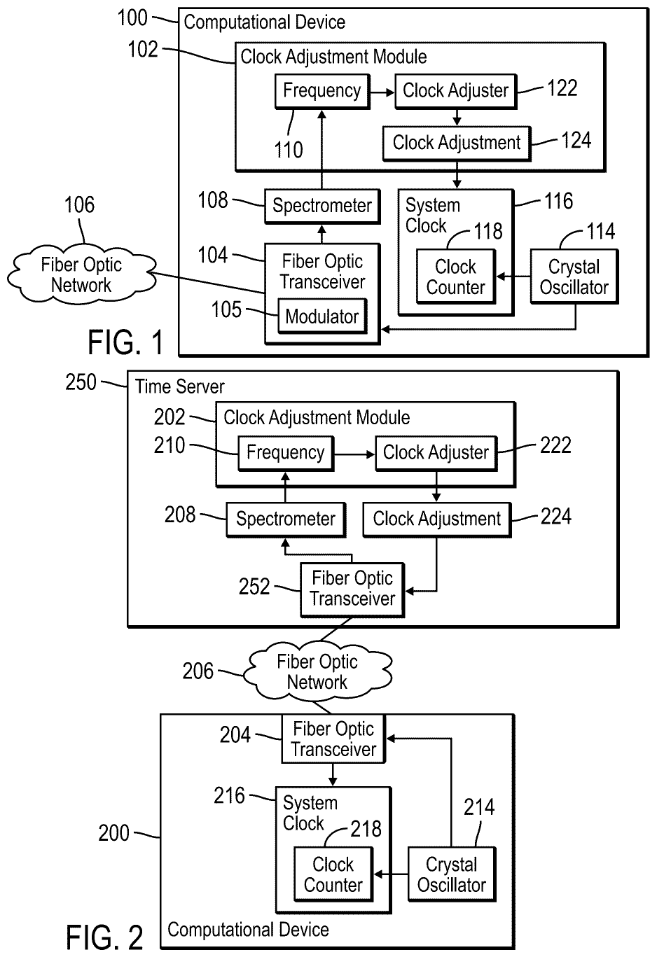

FIG. 1 illustrates an embodiment of a computational device 100 that internally includes a clock adjustment module 102 to adjust a clock signal based on a modulated carrier signal from a fiber optic transceiver 104 connected to a fiber optic network 106. The transceiver 104 may include a modulator 105, such as a phase or amplitude modulator, to generate a phase or amplitude modulated optical signal at a carrier frequency based on the oscillator frequency from a crystal oscillator 114. Alternatively, the modulated optical signal used to adjust the clock signal may be received from a device over the network 106. The transceiver 104 forwards the modulated signal to a spectrometer 108 to perform spectral analysis of a spectrum of the modulated signal to determine a frequency 110 of the modulated optical signal received from a remote device over the network 106. The frequency 110 is forwarded to a clock adjuster 112 program to determine a frequency adjustment from the output or tick from a crystal oscillator 114 of a system clock 116 that increments a clock counter 118 in response to oscillations or clicks from the crystal oscillator 114 . . . . The clock counter is incremented every edge rising of the oscillator 114. The frequency from the crystal oscillator comprises a base frequency.

The current time C(t) at the system clock is calculated from a number of ticks n(t) at time t, from the crystal oscillator indicated in the clock counter 118, and an expected nominal frequency ω₀ at the crystal oscillator 114 according to equation (1) below:

$$C ( t ) = \frac{n ( t )}{{ω}_{0}} \qquad ( 1 )$$

The independently calculated current time C^{C}(t) may be calculated from the number of ticks in the clock counter 118 at time t(n(t)) and the frequency (ω_{c}) 110 of the phase modulated signal according to equation (2) below:

$${C}^{c} ( t ) = \frac{n ( t )}{{ω}_{c}} \qquad ( 2 )$$

A disparity between the current time (C(t)) based on the frequency at the crystal oscillator of the system clock and the C^{C}(t) may raise an anomaly detection alert indicating a security issue or component failure at the computational device 100.

A clock adjuster 122 comprises a component that determines a clock adjustment 124 for the system clock 116, such as an adjustment to the current time to modify the rate at which ticks are incremented in the clock counter 118. The frequency adjustment for a computational device i may be denoted as δωᵢ and calculated based on a reference frequency ω_{c}^{o}, such as of the crystal oscillator 114, and the measured frequency

$${ω}_{c}^{i}$$

from the phase modulated optical signal at the transceiver 104 for computational device i.

$${ω}_{c}^{i} = {ω}_{c}^{0} + δ {ω}_{i} \qquad ( 3 )$$

$$cos ( {ω}_{c}^{0} t ) - cos ( {ω}_{c}^{0} t + δ {ω}_{i} t ) = 0 \qquad ( 4 )$$

The clock adjustment 124, such as frequency adjustment δω, may then be used to adjust the frequency at which ticks are measured and recorded in the clock counter.

The above calculations are for a frequency adjustment of a phase modulated optical signa. In alternative embodiments, amplitude modulation of the optical signal by the oscillator signal may be used to determine the adjustment to the clock signal to measure time.

FIG. 2 illustrates an alternative embodiment where the computational device 200 receives a clock adjustment 224 from a time server 250, such as a time and/or frequency adjustment. The time server 250 includes a fiber optic transceiver 252 to generate or to receive a phase modulated optical signal from the fiber optic transceiver 204 of the computational device to be synchronized. The time server 250 further includes a spectrometer 208 to determine the frequency 210 of the modulated optical signal from the computational device 200 and a clock adjustment module 202 having a clock adjuster 222 to produce a clock adjustment 224 as described above with respect to FIG. 1. The clock adjustment 224 is provided to the fiber optic transceiver 252 to forward to the computational device 200 to use to update its system clock 216. The system clock 216 would include a clock counter 218 and crystal oscillator 214 as described above with respect to FIG. 1.

In certain embodiments, the components of the computational device 100 in FIG. 1, such as the clock adjustment module 102, clock adjuster 122, system clock 116, and clock counter 118, may be implemented in an operating system kernel of the computational device 100.

In the time server 250 of FIG. 2, the clock adjustment module 202 and clock adjuster 222 may be implemented in an application program in memory of the time server. The system clock 216 and clock counter 218 may be implemented in an operating system of the computational device 200.

The spectrometer 108, 208 and crystal oscillator 114, 214 may comprise separate hardware components on the motherboard of the computational device 100, 200 and/or time server 250. The fiber optic transceiver may include a phase or amplitude modulator to modulate a signal from the crystal oscillator 214 to produce the phase modulated carrier signal to send to the time server.

The fiber optic transceiver 104, 204 may be part of a network interface card (NIC) or other hardware component capable of receiving fiber optic signals.

The spectrometer 108, 208 may be located in a network switch that receives the phase or amplitude modulated carrier signal to determine the frequency and transmit the frequency to the computational device or time server to use to perform the clock adjustment. The spectrometer obtains a digital device oscillator frequency. The spectrometer decision about frequency/time adjustments can be communicated to each device either via the same optical network or any other network connecting servers and switches. For instance, the determined frequency at an external spectrometer device may be communicated “out-of-band” via a server on-board controller at the time server, which is not controlled by the main server operating system, or directly to the main time server operating system. Communication between the time server and computational devices may also be done through the fiber optical network or an out-of-band network.

In further embodiments, the spectrometer may be implemented in the transceiver 104, 204.

The arrows shown in FIGS. 1 and 2 between the components and objects represent a data flow between the components.

Generally, program modules, such as the program components 102, 116, 122, 202, 216, 222, among others, may comprise routines, programs, objects, components, logic, data structures, and so on that perform particular tasks or implement particular data types. The program components and hardware devices of FIGS. 1 and 2 may be implemented in one or more computer systems, where if they are implemented in multiple computer systems, then the computer systems may communicate over a network.

The computational devices 100, 200 may comprise a computer system, laptop computer, notebook computer, tablet computer, smartphone, virtual machine, wearable computer, server, etc.

The program components 102, 116, 122, 202, 216, 222, among others, may be accessed by a processor from memory to execute. Alternatively, some or all of the program components 102, 116, 122, 202, 216, 222, among others, may be implemented in separate hardware devices, such as Application Specific Integrated Circuit (ASIC) hardware devices.

The functions described as performed by the program components 102, 116, 122, 202, 216, 222, among others, may be implemented as program code in fewer program modules than shown or implemented as program code throughout a greater number of program modules than shown.

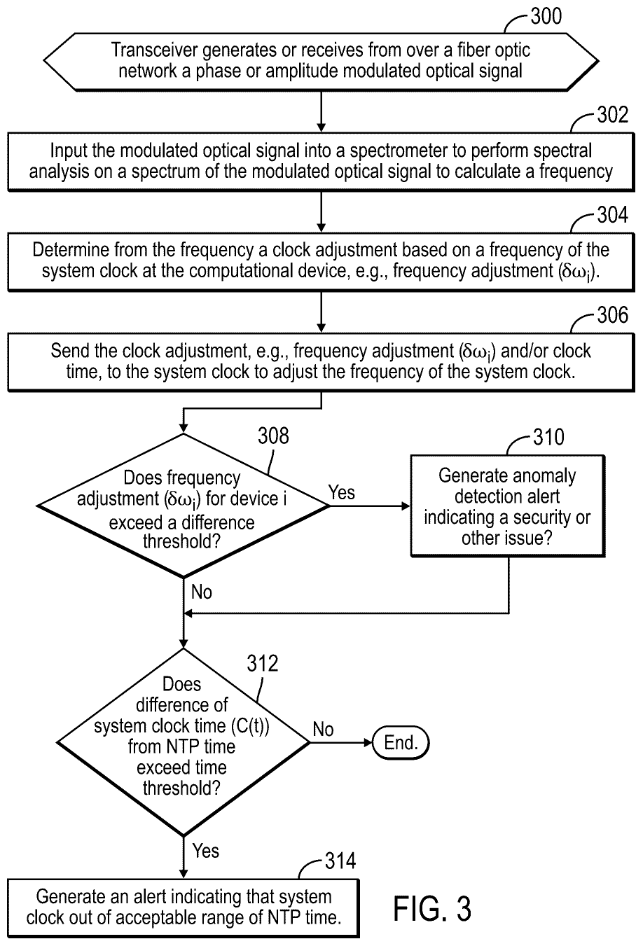

FIG. 3 illustrates an embodiment of operations performed by the embodiments of FIGS. 1 and 2 to determine clock adjustment based on frequency measured from a phase modulated optical signal. The transceiver 104 modulator 105 may generate (at block 300) a phase or amplitude modulated optical signal from an oscillator frequency from the crystal oscillator 114. Alternatively, the transceiver may receive a modulated optical signal from over the fiber optic network 106, 206. In the embodiment of FIG. 2, the modulated signal is from the computational device 200 for which the clock adjustment is being calculated. The modulated optical signal is inputted (at block 302) into a spectrometer 108, 208 to perform spectral analysis on the optical signal to calculate the frequency, e.g., we for computational device i. The clock adjuster 122, 222 may calculate (at block 304) a clock adjustment from the calculated frequency, such as a frequency and/or time adjustment. A frequency adjustment, such as δωᵢ, may be calculated according to equations (3) and (4) above. A time adjustment to the system clock may be calculated as a difference of the time C(t), based on the clock counter 118, 218 from the system clock 116, 216, and the current time C^{C}(t) based on the calculated frequency we, calculated according to equations (1) and (2) above.

The clock adjustment is sent (at block 306) to the system clock to adjust the frequency and/or time at the system clock. In the embodiment of FIG. 1, the clock adjustment is transferred locally to the system clock. In FIG. 2, the clock adjustment is transmitted over the fiber optic network 206 to the computational device 200.

If (at block 308) the frequency adjustment for the computational device exceeds a difference threshold, then the clock adjustment module or other component may generate (at block 310) an anomaly detection alert indicating a security or other issue, such as component failure. From the NO branch of block 308 or from block 310, the system clock or other component may determine (at block 312) whether a difference of time at the system clock and a time from a network time protocol (NTP) time at a remote server (not shown) exceeds a time threshold. If (at block 312) the time threshold is exceeding, then an alert is generated (at block 314) indicating the system clock is outside of an acceptable range of the NTP time. The system clock time may be adjusted to the NTP time. Control ends from the NO branch of block 312.

With the embodiment of FIG. 3, a spectrometer calculates a frequency from a modulated optical signal received at a fiber optic transceiver. This calculated frequency may then be used to determine a frequency adjustment to the frequency outputted from the crystal oscillator and/or a time adjustment to the clock time. In this way, time synchronization is performed using the optical signal of light received at a transceiver.

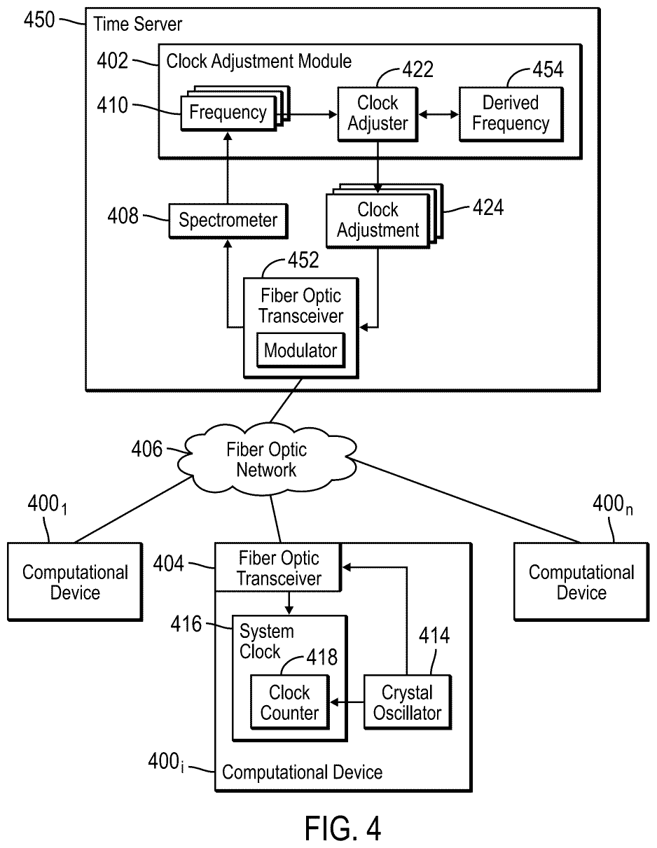

FIG. 4 illustrates an alternative embodiment where there are a plurality of computational devices 400₁ . . . 400ₙ receiving clock adjustments 424, such that that each computational device receives a separate clock adjustment 424 from time server 450, such as a time and/or frequency adjustment. The time server 450 includes a fiber optic transceiver 452 to receive phase or amplitude modulated optical signals from the fiber optic transceivers 404 of the computational devices 400₁ . . . 400n. The time server 450 further includes a spectrometer 408 to determine the frequencies 410 of the modulated optical signals from the computational devices 400₁ . . . 400ₙ, and a clock adjustment module 402 having a clock adjuster 422 to produce a derived frequency 454 from the calculated frequencies 410, such as an average, minimum, maximum or other calculated value. The clock adjuster 422 determines a separate clock adjustment 424 for each of the computational devices 400ᵢ, where i comprises any of the computational devices, based on the derived frequency 454 and the reference frequency produced by the crystal oscillator 414 at the computational device 400j. The clock adjustment 424 is provided to the fiber optic transceiver 452 to forward to the computational device 400; to use to update its system clock 416. The system clock 416 may include a clock counter 418 and crystal oscillator 414 as described above with respect to FIG. 1.

The components in FIG. 4 may operate and be implemented as described with respect to the components of FIGS. 1 and 2.

With the embodiment of FIG. 4, the clock adjuster may perform the operations of equations (3) and (4) but replace the frequency ω_{c}ⁱ with the derived frequency, derived from the frequencies calculated from all of the phase modulated optical signals from the computational devices. In alternative embodiments, the frequency

$${ω}_{c}^{i}$$

used in equations (3) and (4) may comprise the frequency the spectrometer calculates from the phase modulated optical signal from the computational device 400ᵢ. In this way, the frequency adjustment δωᵢ is calculated for each computational device 400ᵢ, where i is the computational device.

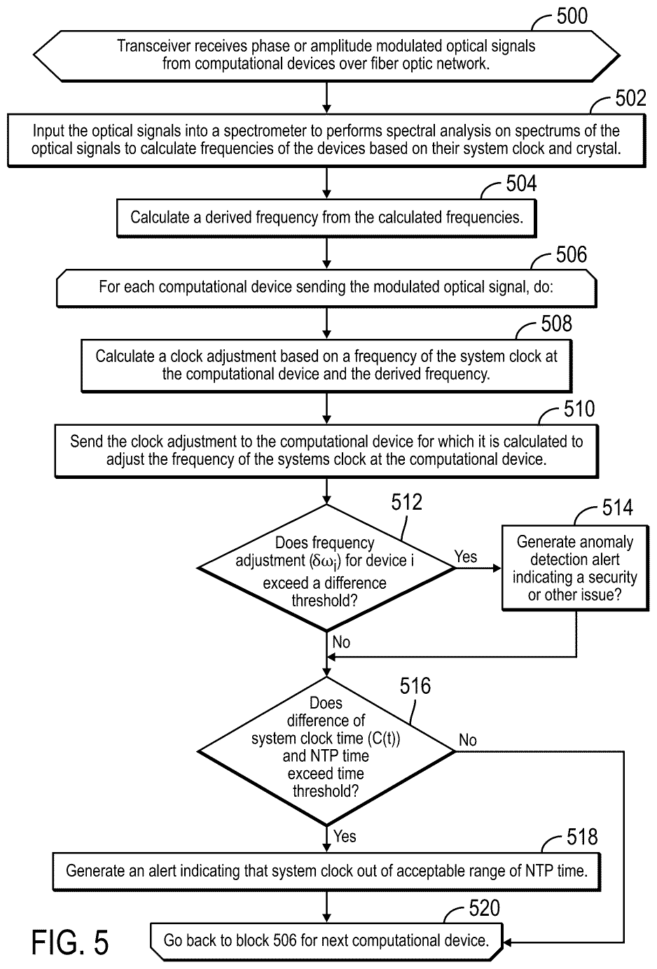

FIG. 5 illustrates an embodiment of operations performed by the time server and computational devices of FIG. 4 to determine clock adjustment based on the frequency measured from the phase modulated optical signals from the computational devices. The transceiver, e.g., 452, receives (at block 500) modulated optical signals over the fiber optic network from the computational devices. In the embodiment of FIG. 4, the modulated signals are from the computational devices for which the clock adjustment is being calculated. The phase or amplitude modulated optical signals are inputted (at block 502) into a spectrometer, e.g., 408, to perform spectral analysis on each the optical signal to calculate the frequency, e.g.,

$${ω}_{c}^{i} ,$$

for computational device i. The clock adjuster, e.g., 422, may calculate (at block 504) a derived frequency derived from the frequences calculated from the modulated optical signals.

A loop of operations is performed at blocks 506 through 522 for each of the calculated devices for which the time server synchronizes time. At block 508, a clock adjustment is calculated based on a frequency of the system clock at the computational device and the derived frequency. The clock adjustment may comprise a frequency and/or time adjustment. A frequency adjustment, such as δωᵢ, may be calculated according to equations (3) and (4) above. A time adjustment to the system clock may be calculated as a difference of the time C(t), based on the clock counter from the system clock, and the current time C^{C}(t) based on the calculated frequency we, calculated according to equations (1) and (2) above.

The clock adjustment is sent (at block 510) over the fiber optic network to the computational device for which it is calculated to adjust the frequency of the system clock at the computational device. In certain embodiments, the clock adjustment is sent in response to determining the calculated frequency differs from the base frequency from the crystal oscillator by a threshold.

If (at block 512) the frequency adjustment for the computational device exceeds a difference threshold, then the clock adjustment module or other component may generate (at block 514) an anomaly detection alert indicating a security or other issue, such as component failure. From the NO branch of block 308 or from block 310, the system clock or time server may determine (at block 516) whether a difference of time at the system clock and a time from a network time protocol (NTP) time at a remote server (not shown) exceeds a time threshold. If (at block 516) the time threshold is exceeded, then an alert is generated (at block 518). From block 518 or the NO branch of block 516, control proceeds (at block 520) back to block 506 if there are any further computational devices to synchronize.

With the embodiment of FIG. 5, a spectrometer calculates a frequency from modulated optical signals received at the fiber optic transceiver. These calculated frequencies produced by the transceivers at the computational devices may then be used to determine a frequency adjustment to the frequency outputted from the crystal oscillator and a time adjustment to the clock time. In this way, synchronization is performed using the optical signal of light received at the time server transceiver from transceivers at the computational devices generating the phase modulated signals to encode information.

The present invention may be a system, a method, and/or a computer program product. The computer program product may include a computer-readable storage medium (or media) having computer-readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

In the flowcharts and description, when there is a condition with different operations described as performed depending on the result of the condition, all results of the condition may occur at different times resulting in the different operations performed for the different results of the condition at different times.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

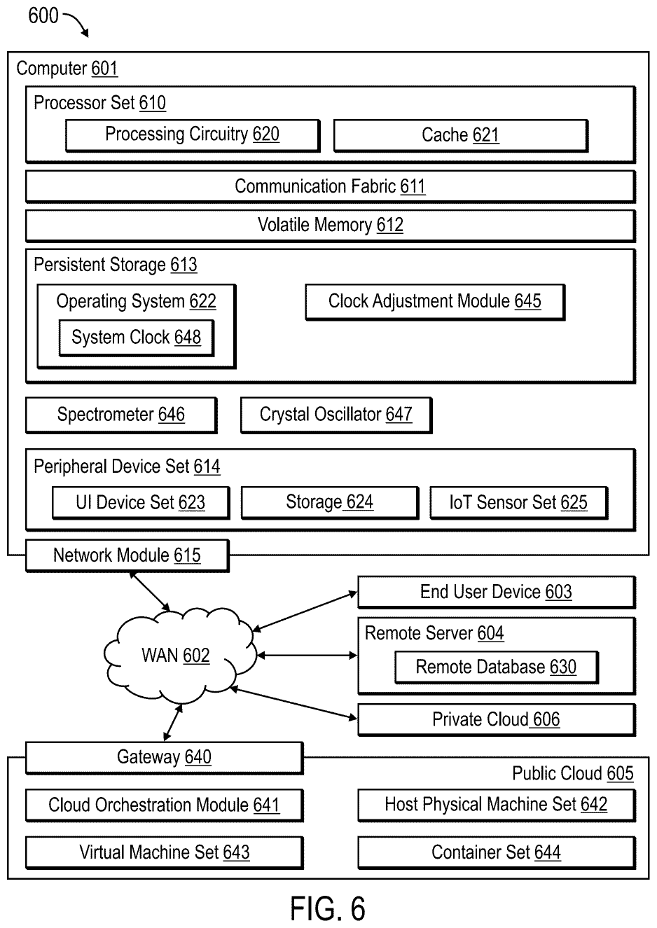

With respect to FIG. 6, computing environment 600 contains an example of an environment for the execution of at least some of the computer code involved in performing the inventive methods, such as operations of the clock adjustment module 645 to determine a clock adjustment from a phase modulated signal received at a transceiver. The clock adjustment module 645 may comprise the clock adjustment modules 102, 202 and 402 as described above with respect to FIGS. 1, 2, and 4. In addition to clock adjustment module 645, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and clock adjustment module 645), peripheral device set 614 (including user interface (UI) device set 623, storage 624, and Internet of Things (IOT) sensor set 625), and network module 615. The network module 615 may comprise a fiber optic NIC and transceiver. The computer 601 may further include a spectrometer 646 to determine the frequency of a phase modulated optical signal received at the network module 615 and a crystal oscillator 647 to produce ticks or oscillations used by system clock 648 to determine time. The computer 601 may comprise the computational device of FIG. 1 or the time server of FIGS. 2 and 4.

Remote server 604 includes remote database 630. Public cloud 605 includes gateway 640, cloud orchestration module 641, host physical machine set 642, virtual machine set 643, and container set 644. The remote server 604 may comprise the NTP server to provide an NTP time.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer-readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 645 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 645 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through a WAN 602. Network module 615 may include hardware, such as modems or Wi-Fi signal transceivers, software for packetizing and/or de-packetizing data for communication network transmission, and/or web browser software for communicating data over the internet. In certain embodiments, the network module 615 comprises a fiber optic NIC having a fiber optic transceiver for optical signals. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer-readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on. In certain embodiments, the EUD 603 may comprise the computational devices in FIGS. 2 and 3.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604. In certain embodiments, the remote server 604 may comprise the NTP server to provide the NTP time.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

CLOUD COMPUTING SERVICES AND/OR MICROSERVICES (not separately shown in FIG. 6): private and public clouds 606 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The letter designators, such as i and n, among others, are used to designate an instance of an element, i.e., a given element, or a variable number of instances of that element when used with the same or different elements.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims herein after appended.

What is claimed is:

1. A computer implemented method for correcting a system clock in a computational device, comprising:
inputting a modulated optical signal from a transceiver to a spectrometer to calculate a frequency from a spectrum of the modulated optical signal;
determining a clock adjustment to the system clock based on the calculated frequency; and
sending the clock adjustment to adjust the system clock to measure time at the calculated frequency.

2. The computer implemented method of claim 1, further comprising:
receiving, at the transceiver, a clock signal from a crystal oscillator; and
modulating, at the transceiver, an optical signal generated from the clock signal to produce the modulated optical signal.

3. The computer implemented method of claim 1, wherein the modulated optical signal comprises a modulated carrier signal from which the frequency is calculated, wherein the modulated carrier signal comprises one of a phase modulated carrier signal and an amplitude modulated carrier signal.

4. The computer implemented method of claim 1, wherein the clock adjustment comprises a frequency adjustment to apply to a base frequency produced by a crystal oscillator of the computational device to measure time at the calculated frequency.

5. The computer implemented method of claim 1, wherein the modulated optical signal is received from a computational device over a fiber optic network, further comprising:
determining a clock adjustment for the system clock in the computational device, wherein the sending the clock adjustment comprises transmitting the clock adjustment to the computational device to cause the computational device to adjust the system clock to measure time according to the calculated frequency.

6. The computer implemented method of claim 1, wherein the modulated optical signal is received at the computational device and the spectrometer is located in the computational device to calculate the frequency to determine the clock adjustment, wherein the sending the clock adjustment comprises applying the clock adjustment to alter a frequency from a crystal oscillator at which time is measured.

7. The computer implemented method of claim 1, further comprising:
determining, using a network time protocol, a first time;
determining whether a second time at the system clock differs from the first time by a threshold; and
generating a time alert indicating an issue with the time at the system clock in response to the determining that the second time differs from the first time by the threshold.

8. The computer implemented method of claim 1, further comprising:
determining whether the calculated frequency differs from a frequency at the system clock, wherein the sending the clock adjustment to adjust the system clock is performed in response to determining that the calculated frequency differs from the frequency at the system clock.

9. The computer implemented method of claim 1, further comprising:
receiving modulated optical signals from a plurality of computational devices, wherein the inputting the modulated optical signal to the spectrometer comprises inputting the received modulated optical signals to the spectrometer to calculate frequencies for the computational devices,
wherein the determining the clock adjustment comprises processing the calculated frequencies to determine a derived frequency based on the calculated frequencies, and
wherein the sending the clock adjustment comprises sending clock adjustments to the computational devices to adjust system clocks to measure time according to the derived frequency.

10. The computer implemented method of claim 1, further comprising:
receiving modulated optical signals from a plurality of computational devices, wherein the inputting the modulated optical signal to the spectrometer comprises inputting the received modulated optical signals to the spectrometer to calculate frequencies for the computational devices,
wherein the determining the clock adjustment comprises calculating frequency adjustments for the computational devices from the calculated frequencies for the computational devices, and
wherein the sending the clock adjustment comprises sending the frequency adjustments to the computational devices to adjust system clocks at the computational devices.

11. A computer system for correcting a system clock in a computational device, comprising:
a processor set;
one or more computer-readable storage media; and
program instructions stored on the one or more computer-readable storage media to cause the processor set to perform operations comprising:
inputting a modulated optical signal from a transceiver to a spectrometer to calculate a frequency from a spectrum of the modulated optical signal;
determining a clock adjustment to the system clock based on the calculated frequency; and
sending the clock adjustment to adjust the system clock to measure time at the calculated frequency.

12. The computer system of claim 11, wherein the operations further comprise:
receiving, at the transceiver, a clock signal from a crystal oscillator; and
modulating, at the transceiver, an optical signal generated from the clock signal to produce the modulated optical signal.

13. The computer system of claim 11, wherein the modulated optical signal is received from a computational device over a fiber optic network, wherein the operations further comprise:
determining a clock adjustment for the system clock in the computational device, wherein the sending the clock adjustment comprises transmitting the clock adjustment to the computational device to cause the computational device to adjust the system clock to measure time according to the calculated frequency.

14. The computer system of claim 11, wherein the operations further comprise:
receiving modulated optical signals from a plurality of computational devices, wherein the inputting the modulated optical signal to the spectrometer comprises inputting the received modulated optical signals to the spectrometer to calculate frequencies for the computational devices,
wherein the determining the clock adjustment comprises processing the calculated frequencies to determine a derived frequency based on the calculated frequencies, and
wherein the sending the clock adjustment comprises sending clock adjustments to the computational devices to adjust system clocks to measure time according to the derived frequency.

15. The computer system of claim 11, wherein the operations further comprise:
receiving modulated optical signals from a plurality of computational devices, wherein the inputting the modulated optical signal to the spectrometer comprises inputting the received modulated optical signals to the spectrometer to calculate frequencies for the computational devices,
wherein the determining the clock adjustment comprises calculating frequency adjustments for the computational devices from the calculated frequencies for the computational devices, and
wherein the sending the clock adjustment comprises sending the frequency adjustments to the computational devices to adjust system clocks at the computational devices.

16. A computer program product for correcting a system clock in a computational device, comprising:
one or more computer-readable storage media; and
program instructions stored on the one or more computer-readable storage media to perform operations comprising:
inputting a modulated optical signal from a transceiver to a spectrometer to calculate a frequency from a spectrum of the modulated optical signal;
determining a clock adjustment to the system clock based on the calculated frequency; and
sending the clock adjustment to adjust the system clock to measure time at the calculated frequency.

17. The computer program product of claim 16, wherein the operations further comprise:
receiving, at the transceiver, a clock signal from a crystal oscillator; and
modulating, at the transceiver, an optical signal generated from the clock signal to produce the modulated optical signal.

18. The computer program product of claim 16, wherein the modulated optical signal is received from a computational device over a fiber optic network, wherein the operations further comprise:
determining a clock adjustment for the system clock in the computational device, wherein the sending the clock adjustment comprises transmitting the clock adjustment to the computational device to cause the computational device to adjust the system clock to measure time according to the calculated frequency.

19. The computer program product of claim 16, wherein the operations further comprise:
receiving modulated optical signals from a plurality of computational devices, wherein the inputting the modulated optical signal to the spectrometer comprises inputting the received modulated optical signals to the spectrometer to calculate frequencies for the computational devices,
wherein the determining the clock adjustment comprises processing the calculated frequencies to determine a derived frequency based on the calculated frequencies, and
wherein the sending the clock adjustment comprises sending clock adjustments to the computational devices to adjust system clocks to measure time according to the derived frequency.

20. The computer program product of claim 16, wherein the operations further comprise:
receiving modulated optical signals from a plurality of computational devices, wherein the inputting the modulated optical signal to the spectrometer comprises inputting the received modulated optical signals to the spectrometer to calculate frequencies for the computational devices,
wherein the determining the clock adjustment comprises calculating frequency adjustments for the computational devices from the calculated frequencies for the computational devices, and
wherein the sending the clock adjustment comprises sending the frequency adjustments to the computational devices to adjust system clocks at the computational devices.
